(19) United States
(12) Patent Application Publication
(10) Pub. No.: US 2025/0214520 A1
(43) Pub. Date: Jul. 3, 2025

(54) BINDING MEMBER

(71) Applicant: DAIWA KASEI INDUSTRY CO.,LTD., Okazaki-shi (JP)

(72) Inventors: Toshiaki HOSHINO, Okazaki-shi (JP); Atsushi TOKUNAGA, Okazaki-shi (JP); Katsuya HIRAKAWA, Toyota-shi (JP)

(21) Appl. No.: 18/950,519

(22) Filed: Nov. 18, 2024

(30) Foreign Application Priority Data
Dec. 28, 2023 (JP) 2023-223151

(51) Int. Cl. B60R 16/02; H02G 3/32

(52) U.S. Cl. CPC B60R 16/0215; H02G 3/32

(57) ABSTRACT

Provided is a belt-type binding member including a buckle portion located at a lower position than conventional ones, and a wire harness that is unlikely to receive interference from an elastic engagement piece when bound with a belt. A binding member integrally includes a belt portion and a buckle portion. A proximal end of the belt portion separates into right and left so as to create a cavity therebetween, and the proximal end branched on both the right and the left side is connected to a lower surface of the buckle portion. An elastic locking piece extends beyond a connection position between the belt portion and the lower surface in a belt insertion direction of a belt insertion hole, and enters the cavity when a portion on a free-end side is elastically deformed downward.

### RELATED APPLICATIONS

This application claims the priority of Japanese Patent Application No. 2023-223151 filed on Dec. 28, 2023. The disclosure of the prior application is hereby incorporated by reference herein in its entirety.

### BACKGROUND OF THE INVENTION

### Field of the Invention

The invention relates to a binding member for binding and holding an elongated wire routing material.

### Description of Related Art

In a case where an elongated wire routing material such as a wire harness is

routed in a vehicle, a clamp (binding member) by which the wire routing material is bound and held at predetermined portions thereof in a longitudinal direction is fixed to a certain position on a vehicle-body side (see Japanese Laid-Open Patent Publication No. 2007-166781, Japanese Laid-Open Patent Publication No. 2017-44243, Japanese Patent No. 6445309, and Japanese Laid-Open Patent Publication No. 2011-202777). Such a clamp may be of a tape type, a belt type, or other types. In a tape-type clamp, a plate-shaped sleeve portion formed integrally with the clamp, and a wire harness are wound together with a separate tape, whereby the wire harness is bound and held. In a belt-type clamp, a wire harness is wound with a belt formed integrally with the clamp, and the belt is inserted in a buckle formed at a proximal-end portion of the belt, whereby the wire harness is bound and held.

In recent years, development of an automatic binding device that causes such a clamp to automatically bind a wire routing material such as a wire harness, has been considered. The clamp used in the above case is a belt type clamp and not a tape type clamp. In a case where the tape-type clamp is used, manual operations are more suitable, and it is difficult to achieve automation by a device.

When comparing a tape-type clamp 101 (tape 101T) as shown in FIG. 10 and FIG. 11 to a belt-type clamp 102 (belt portion 102A) as shown in FIG. 12 and FIG. 13, the tape-type clamp 101 can be advantageously formed so at to have a reduced height since no buckle portion 102B is provided. That is, when a clamp is fixed to a panel 300 on a vehicle-body side, the clamp having the reduced height can be disposed with a distance h (see FIG. 11 and FIG. 13) between the panel 300 on the vehicle-body side and the wire harness 200 being reduced, and thus a space S (reference character 400 denotes a structural body on a cabin-interior side) on the wire harness 200 can be widened. Accordingly, the degree of freedom of the wire route can be increased. In addition, even if the structural body 400 (surrounding object) is present in the space S, a gap having a sufficient width j can be ensured between the structural body 400 and the wire harness 200, so that interference or the like is unlikely to occur.

Meanwhile, in a case where the belt-type clamp 102 (see FIG. 12 and FIG. 13) has such a structure that, if a distal-end-side portion of an elastic engagement piece for preventing disengagement when a belt 102A has been inserted in a buckle portion 102B comes into contact with a wire harness 200, the elastic engagement piece is pressed onto the wire harness 200 when the wire harness 200 is bound with the belt 102A and thus is unlikely to bend, so that insertion of the belt 102A to the buckle portion 102B consumes time and effort.

### SUMMARY OF THE INVENTION

An object of the invention is to provide a belt-type binding member including a buckle portion located at a lower position than conventional ones, and a wire harness that is unlikely to interfere with an elastic engagement piece when bound with a belt.

In order to solve the above-described problem, a binding member includes a belt portion and a buckle portion in an integral manner, the belt portion winding around an outer periphery of an elongated wire routing material, the buckle portion allowing the belt portion to be inserted from a distal end of the belt portion in a belt insertion hole and be fixed, wherein
the buckle portion has an upper-surface portion disposed on an upper side, a lower-surface portion disposed on a lower side, and lateral-surface portions disposed on right and left sides of the belt insertion hole,
the lower-surface portion includes an elastic engagement piece that extends from an entrance side toward an exit side of the belt insertion hole, and is supported in a cantilevered manner so that a distal end of the extending elastic engagement piece is a free end, and on which engagement claws protruding upward are formed on the free-end side,
engagement grooves that engage with the engagement claws in a direction opposite to a belt insertion direction when the belt portion is inserted from the entrance side in the belt insertion hole, are continually formed on the belt portion so as to be arranged in a belt longitudinal direction,
a proximal end of the belt portion branches into right and left so as to create a cavity therebetween, and the proximal end branched on both the right and the left is connected to a lower surface (bottom surface) of the buckle portion, and
the elastic engagement piece is provided so as to extend beyond a connecting position between the belt portion and the lower surface of the buckle portion in the belt insertion direction of the belt insertion hole, and so as to enter the cavity when a portion on the free-end side is elastically deformed downward.

In the above configuration, the bound and held wire harness is positioned so as to lean against the entrance side of the belt insertion hole, on the lower surface (bottom surface) of the buckle portion. The elastic engagement piece extends from the entrance side toward the exit side of the belt insertion hole beyond the connecting position to the belt portion, and has a portion on a fixed side disposed on the entrance side with respect to the connecting position to the belt portion, and the portion on the free-end side (engagement-claw side), which is mainly involved with bending, disposed on the exit side with respect to the connecting position to the belt portion. Thus, the elastic engagement piece is unlikely to receive interference from the bound and held wire harness, and, in particular, bending on the free-end side is unlikely to be inhibited.

In the above configuration, when the elastic engagement piece is elastically deformed such that the portion on the free-end side bends downward, the elastic engagement piece enters the cavity formed between branched portions of the proximal end of the belt portion. The elastic engagement piece enters so as to be protected between the branched portions (fork shaped-portion) of the proximal end of the belt portion, and thus is unlikely to receive interference from the bound and held wire harness. Accordingly, the portion on the free-end side of the elastic engagement piece can assuredly bend downward.

A lowest surface of the buckle portion can be formed so as to include and be flush with a lower surface of the elastic engagement piece.

In the above configuration, the elastic engagement piece bends downward with respect to the lower surface position of the buckle portion, toward an outer space located beneath the buckle portion. Conventionally, a space for bending of an elastic engagement piece is ensured inside a buckle portion (within an upper-lower width from a lower surface to an upper surface of the buckle portion) (see FIG. 4 of Japanese Laid-Open Patent Publication No. 2017-44243, FIG. 4 of Japanese Patent No. 6445309, and FIG. 3 of Japanese Laid-Open Patent Publication No. 2011-202777), and the elastic engagement piece is protected by right and left wall portions of the buckle portion even when the elastic engagement piece bends. However, the buckle portion cannot be made thin because of the presence of the space. In the above configuration, since the outer space located beneath the buckle portion is used as a space for bending of the elastic engagement piece, the lower-surface portion of the buckle portion can be made thin. When the elastic engagement piece bends, the elastic engagement piece enters the fork shaped-portion of the proximal end of the belt portion, and is unlikely to receive interference from the bound and held wire harness, so that the portion on the free-end side can assuredly bend downward.

The binding member includes an engaging portion for assembly into a vehicle-body side (another member), wherein
two said buckle portions are formed so as to be arranged such that the belt insertion directions are parallel to each other, and the belt portions are formed so as to extend downward from the lower surfaces of the buckle portions, respectively, and
the engaging portion can be formed so as to protrude upward on a plate-shaped connecting portion that connects lateral surfaces facing each other of the two buckle portions.

In the above configuration, similarly to a tape-type clamp (see FIG. 10 and FIG. 11), the wire harness is bound at two positions between which the engaging portion is disposed, and the wire harness can be linearly disposed between the two positions. Accordingly, since the wire harness can be bound and held so as to be linearly retained between the two positions, the wire harness can be prevented from bending and interfering with another structured body (e.g., contact or the like in the vicinity of A between a member 300 (convex portion 301) on the vehicle-body side and a wire harness 200 shown in FIG. 12 and FIG. 13) in such a linear section. In addition, the connecting portion is disposed so as to face the vehicle-body side in the linear section, and thus contact between the vehicle-body side and the wire harness can be prevented by the connecting portion.

The lateral-surface portion can have a protrusion formed so as to protrude outward.

In the above configuration, the protrusion may be a grip portion to be gripped by an automatic binding device, and the protrusion is gripped such that the grip portion is engaged, whereby the position and the orientation of the binding member can be constant in a grip state.

### BRIEF DESCRIPTION OF THE DRAWINGS

FIG. 1 is a back-side perspective view of a binding member according to a first embodiment;

FIG. 2 is a front-side perspective view of the binding member in FIG. 1;

FIG. 3 is a perspective view illustrating the binding member in FIG. 1 in a binding state;

FIG. 4 is a cross-sectional view of the binding member in the binding state in

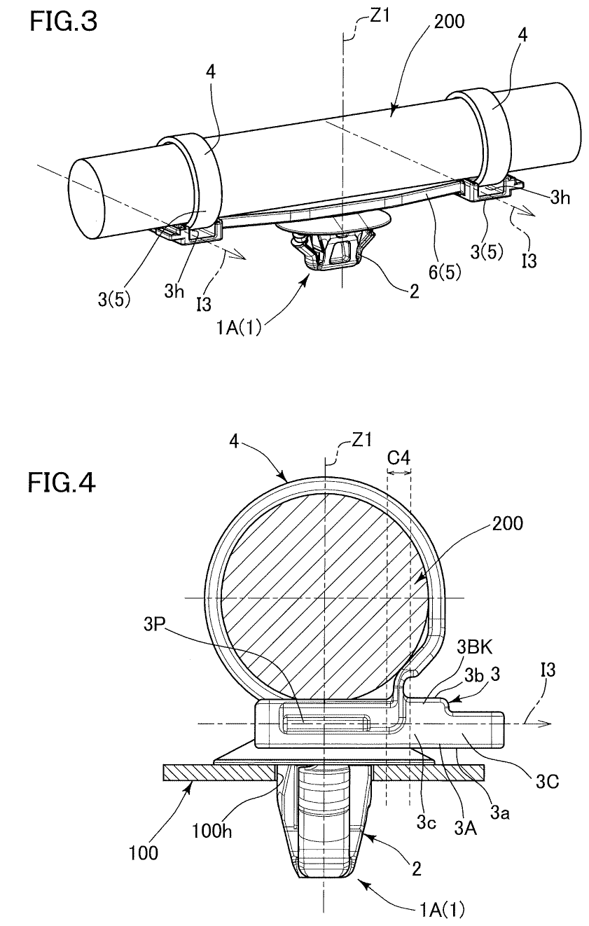

FIG. 3, as seen from a lateral side;

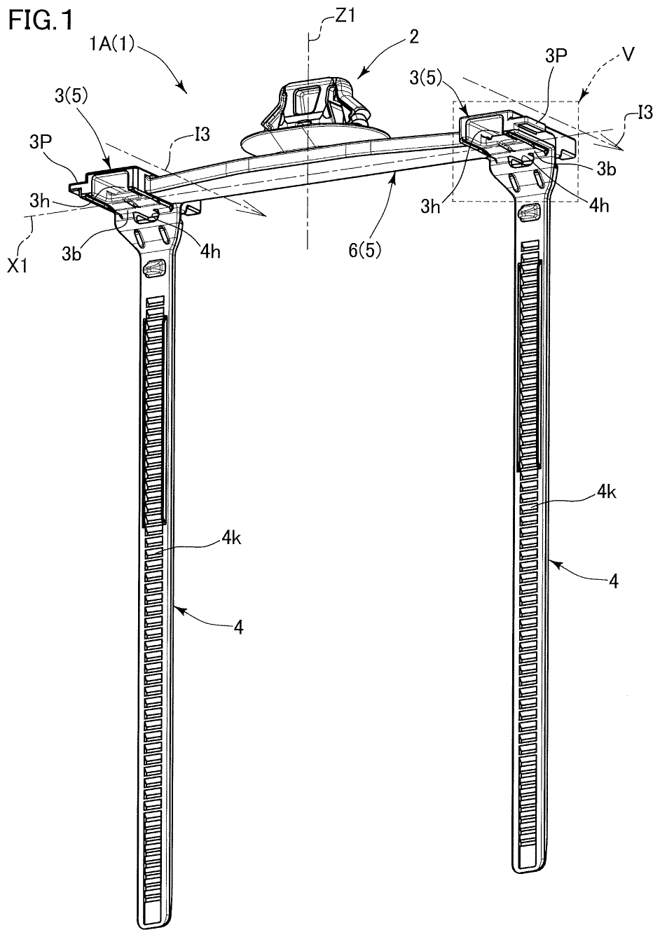

FIG. 5 is an enlarged view of a part V in FIG. 1;

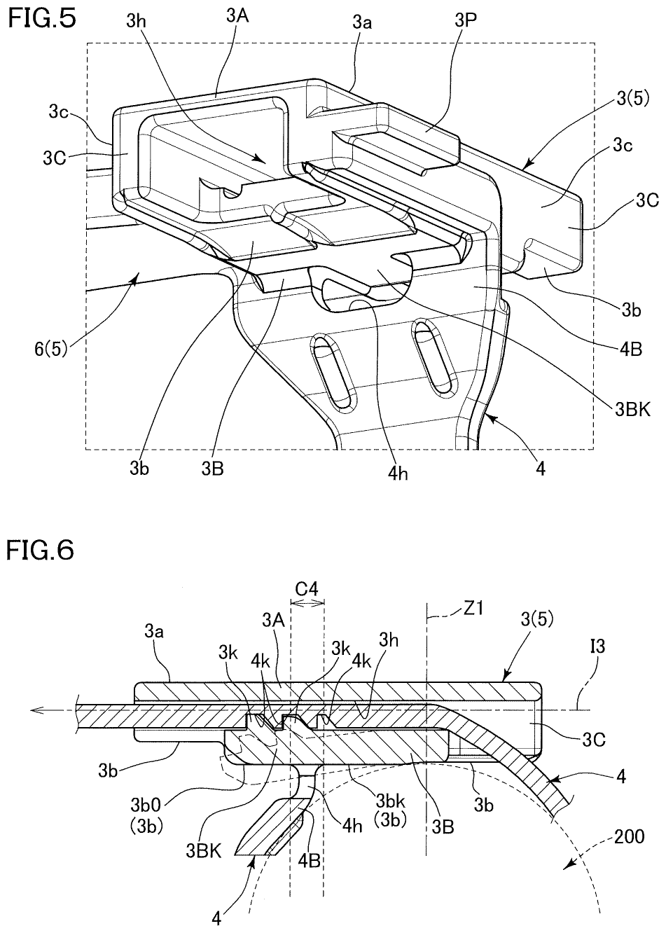

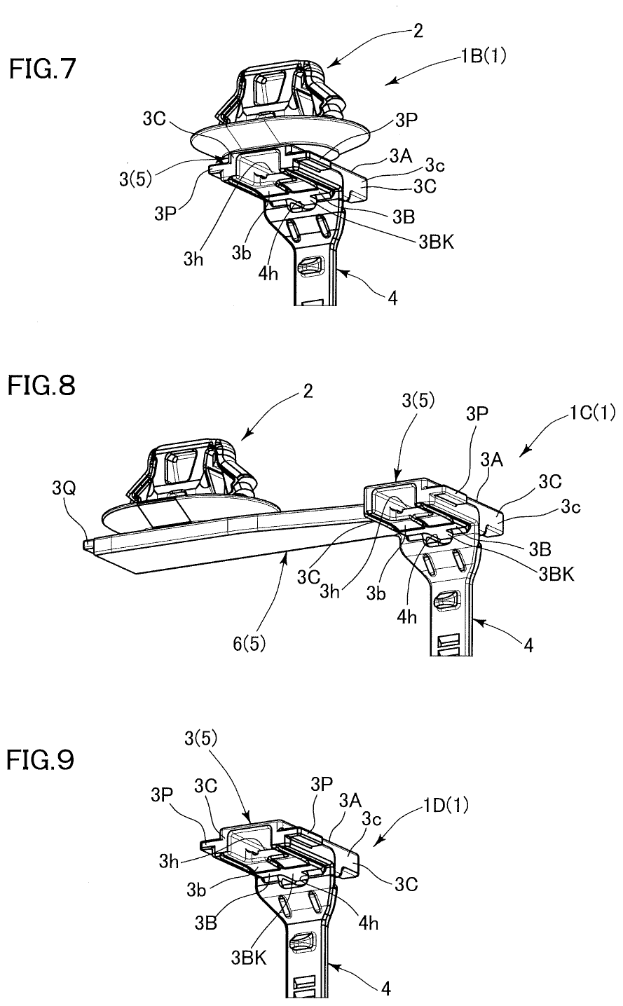

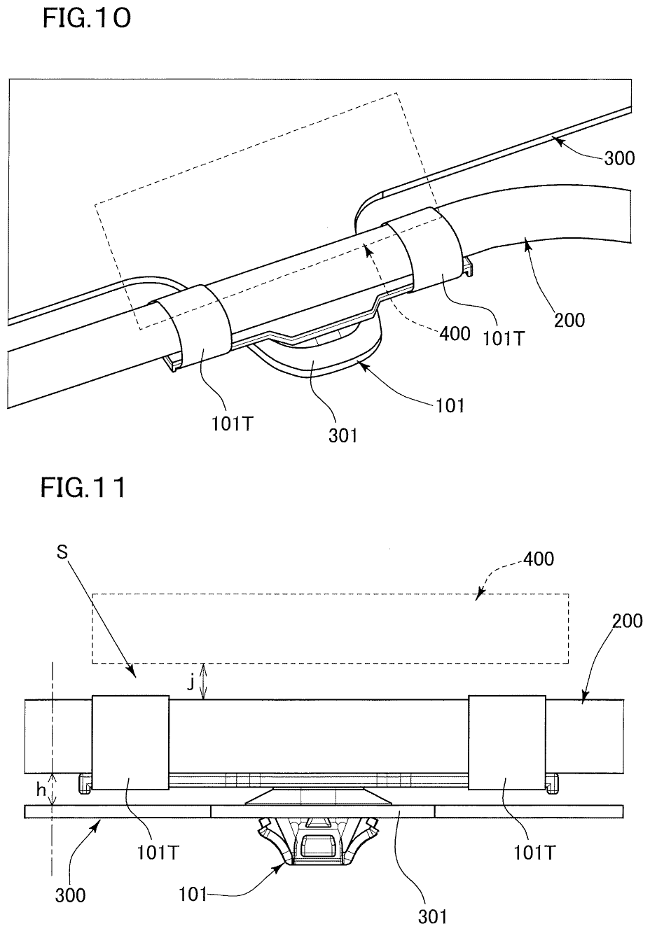

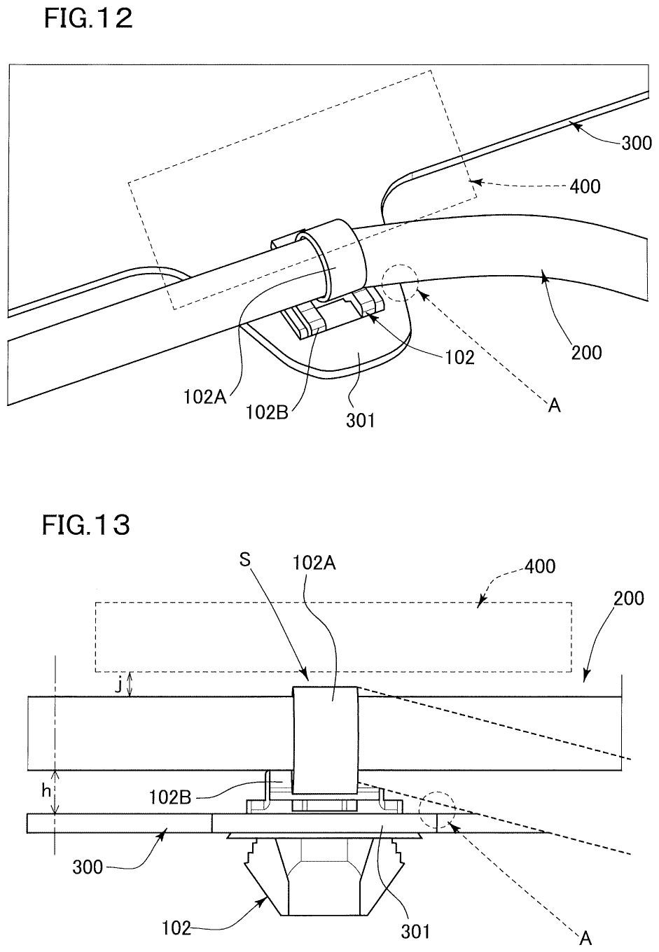

FIG. 6 is an enlarged cross-sectional view of a buckle portion in FIG. 4;

FIG. 7 is a back-side perspective view of an upper portion of a binding member according to a second embodiment;

FIG. 8 is a back-side perspective view of an upper portion of a binding member according to a third embodiment;

FIG. 9 is a back-side perspective view of an upper portion of a binding member according to a fourth embodiment;

FIG. 10 is a perspective view of a conventional tape-type clamp mounted to a vehicle body panel;

FIG. 11 is a front view of FIG. 10;

FIG. 12 is a perspective view of a conventional belt-type clamp mounted to a vehicle body panel; and

FIG. 13 is a front view of FIG. 12.

### DETAILED DESCRIPTION

Hereinafter, embodiments of the invention will be described with reference to the drawings.

A binding member 1 integrally includes a base portion and a wire-routing-material binding portion. The binding member 1 may integrally include an other-member fixing portion, the base portion, and the wire-routing-material binding portion.

When the other-member fixing portion is integrally included, the other-member fixing portion is formed so as to protrude on a first side of the base portion of the binding member 1, and the wire-routing-material binding portion is formed on a second side opposite to the first side of the base portion.

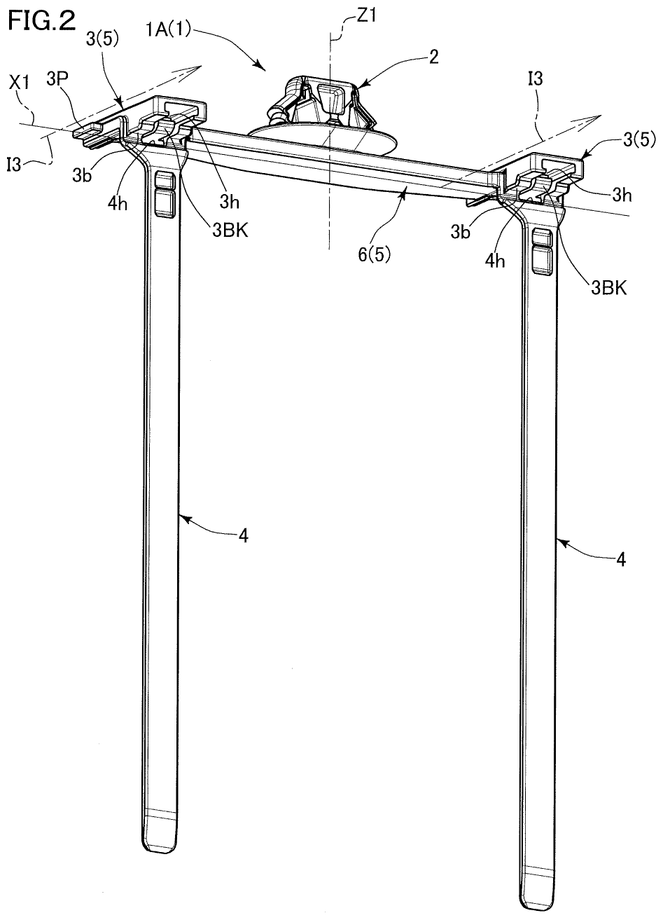

As shown in FIG. 1 and FIG. 2, the binding member 1 according to a first

embodiment is a belt clamp 1A including: belt portions 4 (binding portions) that wind around the outer periphery of an elongated wire routing material 200 (see FIG. 3 and FIG. 4), as the wire-routing-material binding portion; an anchor portion 2 (engaging portion) for assembly into a vehicle-body side, as the other-member fixing portion; and buckle portions 3 (binding and fixing portions) that are provided on proximal ends of the belt portions 4 and that allow the belt portions 4 to be inserted from distal ends of the belt portions 4 in belt insertion holes 3h and be fixed, respectively, as the base portion 5. The wire routing material 200 is a wire harness formed of a bundle of a plurality of wires such as a signal line and a power supply line.

The binding member 1 is not limited to the belt clamp 1A as in the invention, and may be a belt-type binding member including a belt portion 4 and a buckle portion 3. In addition, the wire routing material 200 is also not limited to the wire harness, and may be an elongated wire routing material other than the wire harness.

As shown in FIG. 1 and FIG. 2, two buckle portions 3 are formed so as to be arranged such that belt insertion directions I3 are parallel to each other, and the belt portions 4 corresponding to the buckle portions 3 are formed so as to extend downward from lower surfaces 3b of the buckle portions 3, respectively. The anchor portion 2 is formed so as to protrude upward at the center of a plate-shaped connecting portion 6 that connects lateral surfaces 3c (see FIG. 5) facing each other of the two buckle portions 3 and such that an insertion direction (assembling direction) for assembly into the vehicle-body side is an upward direction. The connecting portion 6 is included in the base portion 5 together with the two buckle portions 3, 3.

Each buckle portion 3 has a substantially rectangular parallelepiped shape, and has an upper-surface portion 3A forming an upper-side inner wall, a lower-surface portion 3B forming a lower-side inner wall, and lateral-surface portions 3C, 3C forming right and left-side inner walls of the belt insertion hole 3h (see FIG. 5 and FIG. 6). The belt insertion hole 3h is formed so as to penetrate the buckle portion 3 from a front side (entrance) toward a back side (exit). Here, the belt insertion direction I3 of the belt insertion hole 3h is orthogonal to an up-down direction Z1 and a right-left direction X1 of the belt clamp 1A.

The belt portion 4 is formed on each buckle portion 3 so as to extend downward from the lower-surface portion 3B (lower surface 3b). The anchor portion 2 is formed so as to protrude upward with respect to the upper-surface portion 3A (upper surface 3a) of the buckle portion 3 and such that the insertion direction for assembly into the vehicle-body side is an upward direction.

Here, the anchor portion 2 is a known insertion fixing portion that is inserted in a through hole 100h of a plate material 100 (e.g., vehicle body panel) as shown in FIG. 4, and that is fixed such that disengagement is prevented. The anchor portion 2 is not limited to such a shape, and may have another shape corresponding to an assembly counterpart side.

One of the lateral-surface portions 3C, 3C of each buckle portion 3 has a protrusion 3P (engagement protrusion) formed so as to protrude outward. Here, the protrusions 3P are respectively formed on the lateral surfaces 3c (see FIG. 5) on both outer sides of the base portion structured such that the buckle portion 3, the connecting portion 6, and the buckle portion 3 are arranged side by side in this order. The protrusions 3P are shaped such that changes in the position and the orientation of the protrusions are controlled when recesses corresponding to the protrusions 3P are engaged with the protrusions 3P from the outside.

As shown in FIG. 6, the lower-surface portion 3B of each buckle portion 3 includes an elastic engagement piece 3BK extending from an entrance side (right side in FIG. 6) toward an exit side (left side in FIG. 6) of the belt insertion hole 3h. The elastic engagement piece 3BK is supported in a cantilevered manner so that a distal end of the extending elastic engagement piece 3BK is a free end. Engagement claws 3k protruding upward are formed on the free-end side of the elastic engagement piece 3BK. Here, cutouts extending from the exit side toward the entrance side of the belt insertion hole 3h are formed so as to be arranged side by side in the right-left direction X1 in a region, on the lower side of the belt insertion hole 3h, of the lower-surface portion 3B, and the elastic engagement piece 3BK spans between the cutouts (see FIG. 2).

As shown in FIG. 6, here, a lowest surface 360 of the lower surface 3b of each buckle portion 3 (lower-surface portion 3B) is formed so as to include and be flush with the lower surface 3bk of the elastic engagement piece 3BK.

Each belt portion 4 has engagement grooves 4k that engage with the engagement claws 3k when the belt portion 4 is inserted in the belt insertion hole 3h from the entrance side. The engagement grooves 4k form the recesses out of recesses and protrusions that are continually formed so as to be arranged in a belt longitudinal direction (along the belt longitudinal direction).

In FIG. 6, only the engagement grooves 4k disposed around a section, in which the engagement grooves 4k are engaged with the engagement claws 3k of the elastic engagement piece 3BK, are illustrated, and the engagement grooves 4k disposed in other sections are not shown.

As shown in FIG. 5, the proximal end of each belt portion 4 branches into the right and the left so as to create a cavity 4h therebetween, and the proximal end branched on both the right and left sides (right-left direction X1) is connected to the lower surface 3b (or a bottom surface) of the buckle portion 3 corresponding to the belt portion 4. That is, a proximal-end portion 4B of the belt portion 4 forms a branch-shaped portion that branches into two (Y shape) toward the proximal-end side.

As shown in FIG. 6, the elastic engagement piece 3BK of each buckle portion 3 is provided so as to extend from the entrance side toward the exit side of the belt insertion hole 3h beyond a connecting position C4 between the belt portion 4 and the lower-surface portion 3B (lower surface 3b) in the belt insertion direction I3, and so as to enter the cavity 4h when a portion on the free-end side (left side in FIG. 6) is elastically deformed downward.

Fixing of the belt portion 4 to the buckle portion 3 will be described with reference to FIG. 6.

The belt portion 4 is inserted in the belt insertion hole 3h from the entrance side, to form an annular shape (see FIG. 3 and FIG. 4). The belt portion 4 inserted in the belt insertion hole 3h from the entrance side receives the engagement claws 3k of the buckle portion 3 at the engagement grooves 4k arranged in the belt longitudinal direction. However, the belt portion 4 is pushed along the belt insertion direction I3, whereby the portion on the free-end side (engagement claw 3k side) of the elastic engagement piece 3BK bends downward (lower side in FIG. 6), and the belt portion 4 passes over the engagement claws 3k. Repetition of the above progresses the insertion. When progress (insertion) stops, any of the engagement grooves 4k arranged in the belt longitudinal direction receives the engagement claws 3k, and the engagement grooves 4k and the engagement claws 3k engage with each other in a direction opposite to the belt insertion direction I3, so that the belt portion 4 is fixed to the buckle portion 3 such that disengagement is prevented (disengagement in a direction opposite to the belt insertion direction I3 is prevented).

As shown in FIG. 4, when the belt portion 4 forms an annular shape, the elongated wire routing material 200 is placed on an inner-peripheral side, and then the belt portion 4 is further inserted in the belt insertion hole 3h, whereby the wire routing material 200 is more firmly bound and held. As shown in FIG. 6, the bound and held wire routing material 200 is positioned so as to lean against the entrance side (right side in FIG. 6) of the belt insertion hole 3h, on the lower surface 3b (bottom surface) of the buckle portion 3.

As shown in FIG. 6, the elastic engagement piece 3BK extends from the entrance side toward the exit side of the belt insertion hole 3h beyond the connecting position C4 to the belt portion 4, and the portion on the free-end side (including the engagement claws 3k), which is mainly involved with bending, lies on the exit side (left side in FIG. 6) with respect to the connecting position C4 of the belt portion 4. Thus, the portion on the free-end side of the elastic engagement piece 3BK is unlikely to receive interference from the bound and held wire routing material 200.

In addition, as shown in FIG. 6, when the elastic engagement piece 3BK is elastically deformed such that the portion on the free-end side bends downward, the elastic engagement piece 3BK enters the cavity 4h provided in the proximal-end portion 4B of the belt portion 4 (see a broken line in FIG. 6). Since the proximal-end portion 4B of the belt portion 4 forms a branch shape (fork shape), this entry is ensured.

In the first embodiment, as shown in FIG. 3, a pair of the belt portion 4 and the buckle portion 3 is provided on each of the right side and the left side with respect to the anchor portion 2. Thus, when the wire routing material 200 is bound on the both sides, the wire routing material 200 is linearly held so as to face the linear connecting portion 6 in the section between the pairs.

Although the first embodiment of the invention has been described above, the embodiment is merely illustrative, and the invention is not limited thereto. Various modifications such as additions and omissions may be made based on the knowledge of a person skilled in the art without departing from the scope of the claims.

As shown in FIG. 7 and FIG. 8, binding members 1 according to a second embodiment and a third embodiment are belt clamps 1B, 1C that each include a belt portion 4 as a wire-routing-material binding portion, an anchor portion 2 as an other-member fixing portion, and a buckle portion 3 as a base portion, as in the first embodiment.

As shown in FIG. 7, the belt clamp 1B of the second embodiment includes no connecting portion 6, and the buckle portion 3 and the belt portion 4 are configured as in the first embodiment. The anchor portion 2 is formed so as to protrude upward from an upper-surface portion 3A of the buckle portion 3. Protrusions 3P formed so as to protrude outward are formed bilaterally symmetrical to each other on right and left lateral surfaces 3c, 3c of the buckle portion 3.

As shown in FIG. 8, the belt clamp 1C of the third embodiment is configured such that the anchor portion 2 is formed so as to protrude upward on one end portion of a connecting portion 6, and connection to one lateral surface 3c of the buckle portion 3 is made at the other end portion of the connecting portion 6. The connection is the same as in the first embodiment. The buckle portion 3 and the belt portion 4 are the same as in the first embodiment. The connecting portion 6 of the third embodiment has a protrusion 3Q formed so as to protrude outward at a distal end of the one end portion of the connecting portion 6. The protrusion 3Q is formed bilaterally symmetrical to a protrusion 3P protruding outward from the other lateral surface 3c of the buckle portion 3 on the other end portion side.

As shown in FIG. 9, a binding member 1 of a fourth embodiment is configured as in the second embodiment, but is a binding belt 1D (binding band) including no anchor portion 2 for assembly into the vehicle-body side. A buckle portion 3 and a belt portion 4 are configured as in the first embodiment, and protrusions 3P are formed bilaterally symmetrical to each other on right and left lateral surfaces 3c, 3c of the buckle portion 3.

### DESCRIPTION OF THE REFERENCE CHARACTERS

1 (1A, 1B, 1C, 1D) binding member (belt clamp, binding band)
2 anchor portion (engaging portion, other-member fixing portion)
3 buckle portion (base portion)
3A upper-surface portion
3B lower-surface portion
3C lateral-surface portion
3BK elastic engagement piece
3P protrusion (engagement protrusion, grip protrusion)
3h belt insertion hole
3k engagement claw
4 belt portion (wire-routing-material binding portion)
4B proximal-end portion (proximal-end portion of belt, branch-shaped portion, fork-shaped portion)
4k engagement groove
4h cavity
5 base portion
6 connecting portion (base portion)
200 wire routing material
C4 connecting position
I3 belt insertion direction

What is claimed is:

1. A binding member, comprising a belt portion and a buckle portion in an integral manner, the belt portion winding around an outer periphery of an elongated wire routing material, the buckle portion allowing the belt portion to be inserted from a distal end of the belt portion in a belt insertion hole and be fixed, wherein
the buckle portion has an upper-surface portion disposed on an upper side, a lower-surface portion disposed on a lower side, and lateral-surface portions disposed on right and left sides of the belt insertion hole,
the lower-surface portion includes an elastic engagement piece that extends from an entrance side toward an exit side of the belt insertion hole, and is supported in a cantilevered manner so that a distal end of the extending elastic engagement piece is a free end, and on which engagement claws protruding upward are formed on the free-end side,
engagement grooves that engage with the engagement claws in a direction opposite to a belt insertion direction when the belt portion is inserted from the entrance side in the belt insertion hole, are continually formed on the belt portion so as to be arranged in a belt longitudinal direction,
a proximal end of the belt portion branches into right and left so as to create a cavity therebetween, and the proximal end branched on both the right and the left is connected to a lower surface of the buckle portion, and
the elastic engagement piece is provided so as to extend beyond a connecting position between the belt portion and the lower surface of the buckle portion in the belt insertion direction of the belt insertion hole, and so as to enter the cavity when a portion on the free-end side is elastically deformed downward.

2. The binding member according to claim 1, wherein a lowest surface of the buckle portion is formed so as to include and be flush with a lower surface of the elastic engagement piece.

3. The binding member according to claim 1, further comprising an engaging portion for assembly into a vehicle-body side, wherein
two said buckle portions are formed so as to be arranged such that the belt insertion directions are parallel to each other, and the belt portions are formed so as to extend downward from the lower surfaces of the buckle portions, respectively, and
the engaging portion is formed so as to protrude upward on a plate-shaped connecting portion that connects lateral surfaces facing each other of the two buckle portions.

4. The binding member according to claim 1, wherein the lateral-surface portion has a protrusion formed so as to protrude outward.
